(19) United States
(12) Patent Application Publication
(10) Pub. No.: US 2015/0240847 A1
(43) Pub. Date: Aug. 27, 2015

(54) Self Gripping Clip Apparatus

(71) Applicant: Roylco, Inc., Anderson, SC (US)

(72) Inventor: Peter Nosalik, Waterloo (CA)

(73) Assignee: ROYLCO, INC., Anderson, SC (US)

(21) Appl. No.: 14/190,651

(22) Filed: Feb. 26, 2014

(51) Int. Cl. F16B 2/20

(52) U.S. Cl. CPC F16B 2/20

(57) ABSTRACT

The present invention relates to a clip apparatus adapted to receive and engage a sheet of material such as paper, cardboard, plastic, film, posters or any other material that comes in sheet form. The invention includes a clip assembly having a first arm and a second arm and a plurality of fins that are disposed on an inner surface of the arms that are adapted to receive and engage the sheet of material inserted between the arms. Two or more clips apparatuses can be interconnected by a support member so that the sheet material can be used to create a structure.

### BACKGROUND OF THE INVENTION

1) Field of the Invention

The present invention relates to a clip apparatus adapted to receive and engage a sheet of material such as paper, cardboard, plastic, film, posters or any other material that comes in sheet form. Two or more clip apparatuses can be interconnected by a support member so that the sheet material can be used to create a structure.

2) Description of Related Art

While a variety of clips are known in the prior art, none of these clips are designed to interconnect sheets of material so that children may create structures out of the sheets of material.

Accordingly, it is an object of the present invention to provide a clip apparatus that can receive and engage a sheet of material.

Another object of this present invention is to provide a clip apparatus that can interconnect a plurality of sheets of material.

Another object is to provide a clip apparatus that can be interconnected to a plurality of other clip apparatuses by a support member.

Another object of the present invention is to provide a clip apparatus that can be used to form structures out of the sheet material secured by the clip apparatus.

### SUMMARY OF THE INVENTION

The above objectives are accomplished according to the present invention by providing a clip apparatus for receiving sheet material comprising: a central portion interconnecting at least a first and second clip assembly, wherein the first and second clip assembly each comprise: a first clip arm having a base carried by the central portion and extending to a tip of the first clip arm; a second clip arm having a base carried by the central portion and extending to a tip of the second clip arm; a first fin member disposed on the first clip arm and a second fin member disposed on the second clip arm, wherein the first and second fin members are angled and extend toward the base so that the fins are directed towards the central portion when receiving the sheet material and the fins are directed towards one another and the tip of the first and second clip arms when a force is applied to the sheet material in the direction of the tip of the first and second clip arms; whereby the at least first and the second clip assemblies are adapted to engage the sheet material that is placed between the first and the second clip arms so that the insertion of the sheet material between the first and the second clip arms may be easily accomplished and the fins resist removal of the sheet material from between the first and the second clip arms.

In at least one embodiment, at least one of the first and second clip arms are biased towards a centerline extending between the first and second clip arms. In another embodiment, the clip arms are generally rigid and extend from the central portion towards a centerline extending between the first and second clip arms.

In another embodiment, the first and second clip assemblies are disposed on the central portion in an angled relation to one another so that the angle between the first and second clip assemblies is within the range of ninety to one hundred and eighty degrees.

In one embodiment, a plurality of clip assemblies are disposed on the central portion so that the cross section of the clip apparatus generally defines one of the following shapes, cross, triangle, acute angle and planer.

In another embodiment, the clip apparatus further includes a plurality of fins disposed on the first and second clip arms in an offset manner so that a tip portion of each of the fins disposed on the first clip arm do not align with a tip portion of each of the fins disposed on the second clip arm.

In another embodiment, the fins are flexible so that when the sheet material is inserted between the first and second clip arms a tip portion of the first and second fins moves toward the central portion, bending the first and second fins towards an inner surface of one of the first and second clip arms. When the sheet material is removed from between the first and second clip arms a tip portion of the first fin moves toward a tip portion of the second fin and towards the centerline extending between the first and second clip arms.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective view of an embodiment of the invention;

FIG. 2 shows a perspective view of another embodiment of the invention;

FIG. 3 shows a perspective view of another embodiment of the invention;

FIG. 5a shows a cross section view of a clip assembly of another embodiment of the invention;

FIG. 5b shows a cross section view of a clip assembly of another embodiment of the invention;

FIG. 6 perspective view of another embodiment of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

### DETAILED DESCRIPTION OF A PREFERRED EMBODIMENT

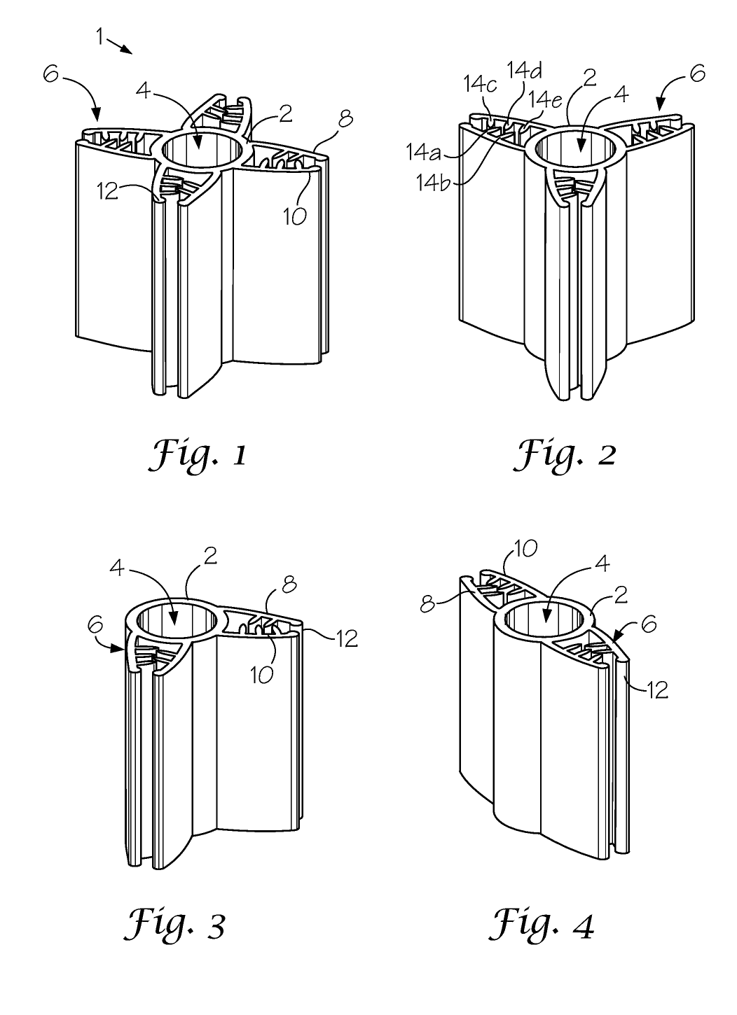

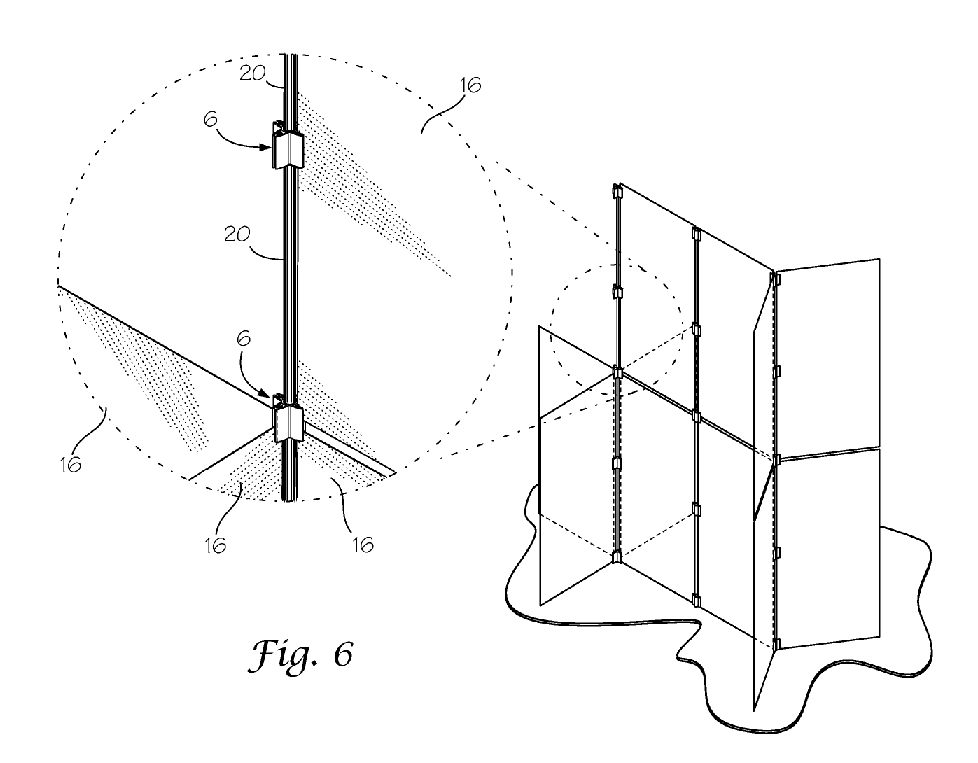

With reference to the drawings, the invention will now be described in more detail. Referring now to FIGS. 1-4, an embodiment of the clip apparatus can generally be seen as A. The clip apparatus includes a central portion 2. The central portion defines a central conduit 4 that is adapted to receive and engage a support member (shown in FIG. 6 as element No. 20). In the shown embodiment, the central portion 2 is circular and defines a circular conduit 4. In alternate embodiments, however, the central portion could be in the shape of a square, rectangle, triangle, oval, diamond or any shape that is generally known. Moreover, the central portion 2 could define the central conduit 4 in any shape that is generally known. In at least one embodiment the shape of the central portion 2 and central conduit 4 have the same shape. In alternate embodiments, however, the central portion and central conduit could be different shapes.

The clip apparatus further includes at least one clip assembly generally shown as 6. In the shown embodiment, the clip apparatus includes between two and four clip assemblies. In alternate embodiments, however, the clip apparatus could have any number of clip assemblies depending on the size and shape of the central portion 2. The clip assemblies comprise a first clip arm 8 and a second clip arm 10 that extend outwardly from the central portion from the base of the clip arm to the tip of the clip arm. In one embodiment, the clip arm has a radiused tip 12. In one embodiment, the clip arms are rigid. In alternate embodiments, however, the clip arms are biased towards a center line extending between the clip arms. In the shown embodiment the clip arms 8 and 10 extend from the central portion 2 in an angled relation so that the base portions of the clip arms are more spaced from one another than the tips 10 of the clip arms.

In one embodiment, a plurality of clip assemblies 6 are disposed on central portion 2 so that the cross section of the clip assembly 1 generally defines one of the following shapes, cross, triangle, acute angle and planer. In alternate embodiments, the plurality of clip assemblies 6 are disposed on central portion 2 so that the cross section of the clip assembly 1 could generally define any number of shapes that are generally known.

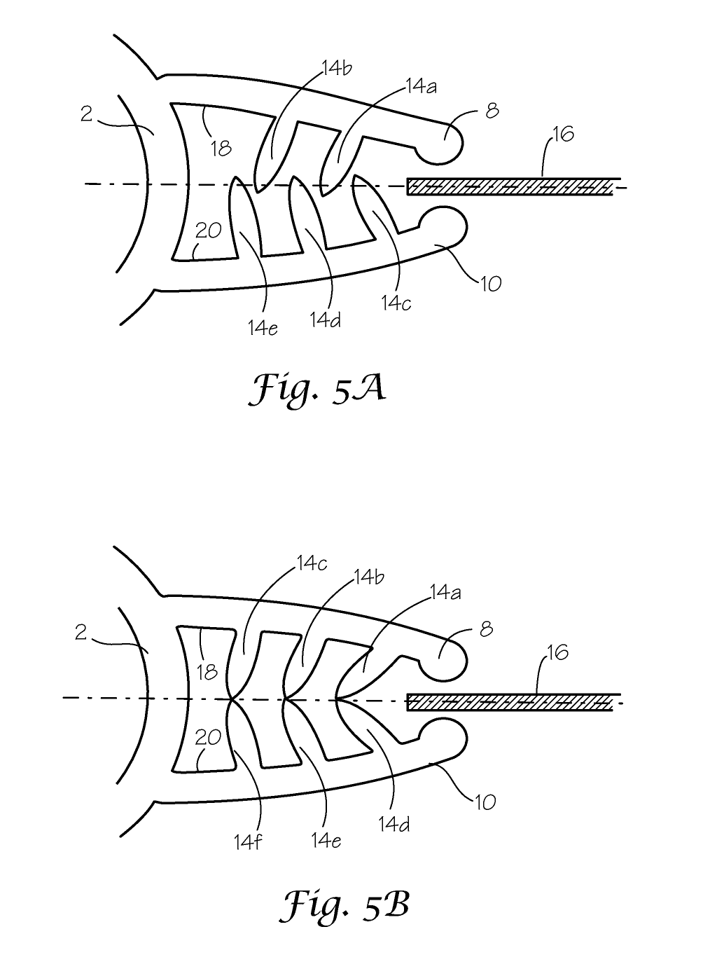

The clip assemblies further include a plurality of fins 14a-14e that are disposed on the inner surface of the clip arms. As can be more clearly seen in FIGS. 5a-5b, the fins are angled so that the extend outwardly from the clip arms towards the central portion 2. In the embodiment shown in FIG. 5a, the fins 14a-14e are offset from one another so that the tip portion of each of the fins 14a-14b disposed on the first clip arm 8 do not align with a tip portion of each of the fins 14c-14e disposed on the second clip arm 10. In the embodiment shown in FIG. 5b, the fins 14a-14f are aligned so that the tip portion of the fins 14a-14c disposed on the first clip arm 8 engage the tip portion of the fins 14d-14f disposed on the second clip arm 10.

The clip assemblies are adapted to receive and engage a sheet of material including, but not limited to paper, cardboard, plastic, film, posters or any other material that comes in sheet form. In one embodiment, the fins 14a-14f are flexible such that when a sheet of material 16 is inserted between the two clip arms, the fins flex backwards towards the central portion 2. Because the base of the tips is attached to the clip arms 8 and 10, only the tip portion of the fins is allowed to move toward the central portion 2, bending the fins in direction A towards the inner surface 18 and 20 clip arms 8 and 10. When the sheet of material 16 is removed from between the clip arms the tip portion of fins 14a -14b move in direction B towards the tip portion the opposing fins 14c-14e fin and vice versa, with all of the fins 14a-14e moving toward the centerline 18 extending between the first and second clip arms along which the sheet of material 16 travels.

The angled nature in which the fins 14a-14f extend from the clip arms 8 and 10 reduce the amount of friction being placed on the sheet of material upon insertion, thus, allowing the sheet of material to be easily inserted between the clip arms. When the sheet of material is being removed, the fins are rotated toward one another as described above, thus, increasing the amount of friction being placed on the sheet of material and making the removal of the material more difficult.

When the fins are offset as shown in FIG. 5a, the length of the fins may be increased, thus, placing more of the fins' surface area in contact with the sheet of material. This increased contact increases the friction placed on the sheet of material by the fins when the sheet of material is being removed and makes it more difficult to remove the sheet of material. In this embodiment, the fins 14a-14e may extend past the centerline 18 along which the sheet of material 16 travels. This greater length allows the fins to better engage the sheet of material when being removed as described above. In the embodiment shown in FIG. 5a, each of the fins 14a-14e extend past the centerline 18. In alternate embodiments, less than all of the fins may extend past the centerline. Because clip arms 8 and 10 are angled towards one another so that the tip portions 12 are closer than the base of the clip arms, the fins 14b and 14e that are closer to the central portion must be longer than fins 14a, 14c and 14d that are closer to the tip 12 of the clip arms in order to extend past the centerline 18. Accordingly, in one embodiment, the fins may have a varying lengths. In other embodiments, however, the fins may all have the same length. In this embodiment, less than all of the fins may extend past the centerline.

In the embodiment shown in FIG. 5b, the angle at which the fins extend from the clip arms may vary. As can be seen in FIG. 5b, fins 14a and 14d extend from the clip arms 8 and 10 at an angle that is more acute than the angle at which fins 14b and 14e extend from the clip arms. However, in alternate embodiments such as the one shown in FIG. 5a, the angle between the fins 14a-14e and clip arms 8 and 10 remains generally constant.

While the shown embodiments include a plurality of fins, alternate embodiments include a single fin disposed on the inner surface 18 of clip arm 8 and a single fin disposed on the inner surface 20 of clip arm 20. By increasing the number of opposing fins, the amount of friction that will be applied to the sheet of material upon its removal from between the clip arms will be increased. Accordingly, any number of fins can be used depending on the desired amount of friction to be applied to the sheet of material.

As can be seen in FIG. 6, the clip apparatuses can be used to create a structure out of the sheet material. The central portion 2 of the clip receives a support member 20, which can be a rod having a shape that corresponds with the shape of the central conduit 4. Once one or more sheets of material 16 have been inserted into the clip assemblies 6, the clip apparatuses 1 can be interconnected by the support member by inserting the support member 20 into the central conduit 4. This allows a structure to be formed using nothing but sheet material supported by the clip apparatuses and the support members. The clip apparatuses and the support members keep the otherwise flimsy sheet material rigid so that the structure can be formed. As can be seen in FIG. 6, a single clip assembly 6 can hold more than one sheet of material at a time by either overlapping the sheets of material or laterally spacing the edge of the sheets within the clip assembly.

While a preferred embodiment of the invention has been described using specific terms, such description is for illustrative purposes only, and it is to be understood that changes and variations may be made without departing from the spirit or scope of the following claims.

What is claimed is:

1. A clip apparatus for receiving sheet material comprising:
a central portion interconnecting at least a first and second clip assembly, wherein said first and second clip assembly each comprise:
a first clip arm having a base carried by said central portion and extending to a tip of said first clip arm;
a second clip arm having a base carried by said central portion and extending to a tip of said second clip arm;
a first fin member disposed on said first clip arm and a second fin member disposed on said second clip arm, wherein said first and second fin members are angled and extend toward said base so that said fins are directed towards said central portion when receiving the sheet material and said fins are directed towards one another and said tip when a force is applied to the sheet material in the direction of said tip of said first and second clip arms; and,
whereby said at least first and said second clip assemblies are adapted to engage the sheet material that is placed between said first and said second clip arms so that the insertion of the sheet material between said first and said second clip arms may be easily accomplished and said fins resist removal of the sheet material from between said first and said second clip arms.

2. The clip apparatus of claim 1 wherein at least one of said first and second clip arms extends from said central portion towards a centerline extending between said first and second clip arms.

3. The clip apparatus of claim 1 wherein said first and second clip assemblies are disposed on said central portion in a spaced relation.

4. The clip apparatus of claim 1 wherein said at least a first and second clip assembly are disposed on said central portion so that the cross section of the clip apparatus generally defines one of the following shapes triangle, cross, planer and acute angle.

5. The clip apparatus of claim 3 wherein said first and second clip assemblies are disposed on said central portion in an angled relation to one another so that the angle between said first and second clip assemblies is within the range of ninety to zero degrees.

6. The clip apparatus of claim 1 further comprising a plurality of fins disposed on said first and second clip arms.

7. The clip apparatus of claim 6 wherein said plurality of fins are disposed in an offset manner so that a tip portion of each of said fin disposed on said first clip arm do not align with a tip portion of each of said fin disposed on said second clip arm.

8. The clip apparatus of claim 1 wherein said central portion defines a central conduit adapted to receive and engage a support structure.

9. The clip apparatus of claim 1 wherein said fins are flexible so that when the sheet material is inserted between said first and second clip arms a tip portion of said first and second fins moves toward said central portion, bending said first and second fins towards an inner surface of one of said first and second clip arms.

10. The clip apparatus of claim 1 wherein said fins are flexible so that when the sheet material is removed from between said first and second clip arms a tip portion of said first fin moves toward a tip portion of said second fin and towards a centerline extending between said first and second clip arms.

11. The clip apparatus of claim 1 wherein at least one of said first and second fins extend past a centerline extending between said first and second clip arms.

12. A clip apparatus for receiving sheet material comprising:
a central portion
a clip assembly carried by said central portion comprising:
a first clip arm having a base carried by said central portion and extending to a tip of said first clip arm;
a second clip arm having a base carried by said central portion and extending to a tip of said second clip arm;
a first fin member disposed on an inner surface of said first clip arm and a second fin member disposed on an inner surface of said second clip arm, wherein said first and second fin members are angled to extend outwardly from said inner surface of said first and second clip arms and toward said base and said first and second fin are in a spaced relation to one another so that a tip potion of said first fin does not align with a tip portion of said second fin; and,
whereby said fins are adapted to receive the sheet material so that said fins are directed towards said central portion when receiving the sheet material and said fins are directed towards one another and said tip of said first and said second clip arms when a force is applied to the sheet material in the direction of said tip of said first and second clip arms.

13. The clip apparatus of claim 12 wherein at least one of said first and second clip arms extends from said central portion towards a centerline extending between said first and second clip arms.

14. The clip apparatus of claim 12 further comprising a plurality of fins disposed on said inner surface of said first clip arm and said inner surface of said second clip arm.

15. The clip apparatus of claim 12 wherein said central portion defines a central conduit adapted to receive and engage a support structure.

16. The clip apparatus of claim 12 wherein said fins are flexible so that when the sheet material is inserted between said first and second clip arms said tip portion of said first and second fins moves toward said central portion, bending said first and second fins towards an inner surface of one of said first and second clip arms.

17. The clip apparatus of claim 12 wherein said fins are flexible so that when the sheet material is removed from between said first and second clip arms said tip portion of said first and second fin moves towards a centerline extending between said first and second clip arms.

18. The clip apparatus of claim 12 wherein said first and second fin are disposed in an offset manner so that a tip portion said first fin does not align with a tip portion of said second fin.

19. The clip apparatus of claim 12 further comprising at least a second clip assembly carried by said central portion comprising:
a first clip arm having a base carried by said central portion and extending to a tip of said first clip arm;
a second clip arm having a base carried by said central portion and extending to a tip of said second clip arm;
a first fin member disposed on said first clip arm and a second fin member disposed on said second clip arm, wherein said first and second fin members are angled and extend toward said base so that said fins are directed towards said central portion when receiving the sheet material and said fins are directed towards one another when a force is applied to the sheet material in the direction of said tip of said first and second clip arms.

20. The clip apparatus of claim 19 wherein said first clip assembly and said at least a second clip assembly are disposed on said central portion so that the cross section of the clip apparatus generally defines one of the following shapes triangle, cross, planer and acute angle.
